(19) United States
(12) Patent Application Publication
(10) Pub. No.: US 2011/0238587 A1
(43) Pub. Date: Sep. 29, 2011

(54) POLICY MANAGEMENT SYSTEM AND METHOD

(75) Inventor: Kenneth R. Owens, JR., St. Louis, MO (US)

(73) Assignee: SAVVIS, INC., Town & Country, MO (US)

(21) Appl. No.: 12/236,436

(22) Filed: Sep. 23, 2008

(51) Int. Cl. G06Q 10/00; G06F 21/00; G06Q 50/00

(52) U.S. Cl. 705/317; 726/1

(57) ABSTRACT

In a policy management system and method, managed services customer policies may be handled on a group or individual basis while taking advantage of information from monitoring and/or auditing of policies for similarly situated managed services customers. The policies may involve compliance standards in varied industries, such as the health care or financial industries. In one aspect, the policies may involve information technology (IT) security standards. In another aspect, the policies may involve both compliance standards and IT security standards.

### CROSS-REFERENCE TO RELATED APPLICATION

The present application is related to commonly-assigned application, entitled “Threat Management System and Method,” Application No. ______, filed the same day as the present application. The contents of that application are incorporated by reference herein.

### BACKGROUND OF THE INVENTION

### FIELD OF THE INVENTION

The present invention relates to a policy management system and method in managed systems.

A managed services provider can provide turn-key solutions for various customers in a wide range of fields requiring information technology (IT) support. Within these fields, there can be various standards for industry compliance. A managed services provider can help customers comply with those standards.

Managed services customers have IT security concerns, of course. A managed services customer may be a participant in a particular industry which may impose certain IT security requirements which go beyond the customer's internal concerns. For example, the health care industry has HIPAA (Health Insurance Portability and Accountability Act) compliance issues with which to deal. HIPAA has associated standards compliance subsets which will be known to those working in the field, relating for example to security, administration, or policy. The banking industry, the securities industry, and other industries which may handle personal or sensitive information also may have various compliance issues. Examples include Sarbanes-Oxley (SOX), Gramm-Leach-Billey Act (GLBA), Federal Information Security Management Act (FISMA), Federal Financial Institutions Examination Council (FFIEC), and Payment Card Industry Data Security Standard (PCI DSS). Others will be known to those working in this field.

Different managed services customers, belonging to different groups or enterprises, and thus having different owners, may have different IT setups, which in turn may promote IT security and standards compliance in some respects, and hinder compliance in others. Various IT standards, such as Control Objectives for Information and Related Technology (CoBIT), Information Technology Infrastructure Library (ITIL), ISO/IEC 27000 series, and the like, may be implicated. Again, other industry standards, giving rise to best practices for compliance, will be known to those working in this field.

Ad hoc compliance review of security measures for these varied customers can be time-consuming and inefficient for a number of reasons. For example, the intricacies and levels of granularity which recent operating systems (such as different versions of Windows XP™ and Windows Vista™) have available can provide an extremely large number of options for providing numerous levels of security.

Previously, managed services providers policed all these different combinations by blocking network traffic to a particular location. This approach may have met security requirements, but presented numerous inconveniences to customers.

It would be desirable to be able to take advantage of information on compliance efforts and policies across customers to provide not only feedback on customer compliance with applicable standards, but also recommendations on best practices for compliance.

### SUMMARY OF THE INVENTION

In view of the foregoing, it is one object of the present invention to devise and implement IT practices for customers in a managed services environment so as to take advantage of cross-pollination opportunities for altering or otherwise amending policies where appropriate to facilitate compliance with applicable standards.

It is another object of the invention to provide feedback to managed services customers regarding standards compliance, and recommendations for best practices in standards compliance.

It is yet another object of the invention to alter or amend standards compliance policies for a managed services customer in accordance with results obtained from audits of such policies for other managed services customers.

It is still another object of the invention to automate one or both of the just-mentioned objects.

### BRIEF DESCRIPTION OF THE DRAWINGS

The present invention is described herein with reference to the accompanying drawings, similar reference numbers being used to indicate functionally similar elements.

FIG. 1 is a high-level block diagram of a system in which the present invention may be implemented.

FIG. 2 is a more detailed, but still high-level diagram identifying some elements of a system in which the present invention may be implemented.

FIG. 3 is a more detailed diagram of a module that may be implemented in one or more of the servers depicted in either FIG. 1 or FIG. 2.

FIGS. 4-7 are flow charts describing aspects of the inventive method.

FIGS. 8-11 are tables depicting security choices for potential pick lists in accordance with one aspect of the invention.

FIG. 12 is a depiction of one of the dashboards available for providing policy assessments.

FIG. 13 is a depiction of another dashboard available for providing risk information.

### DETAILED DESCRIPTION OF EMBODIMENTS

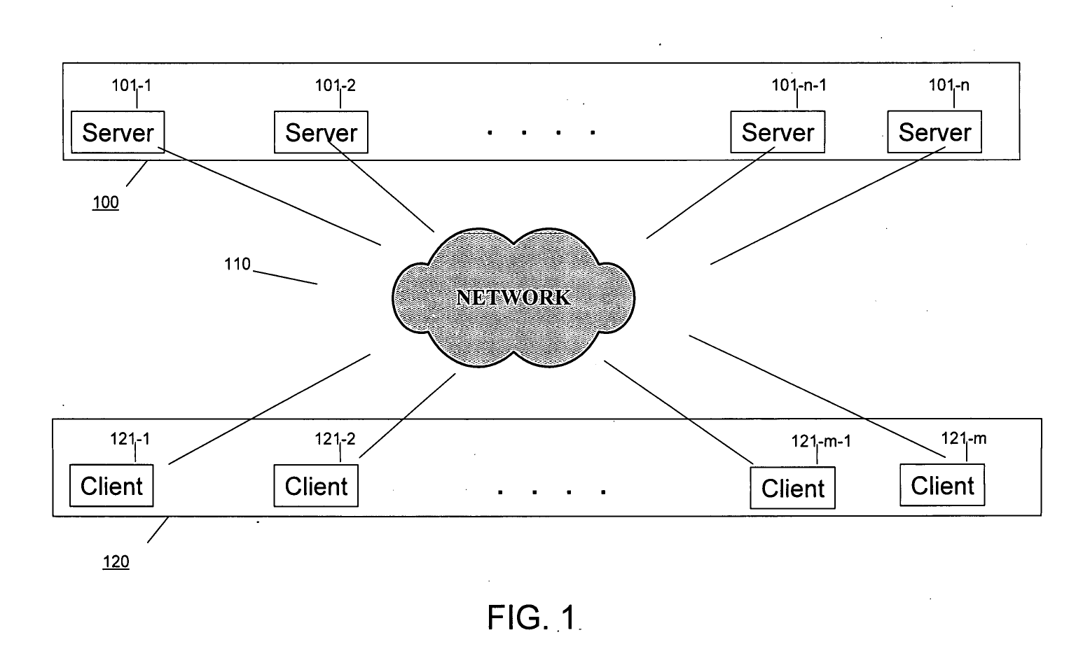

FIG. 1 depicts a system which includes one or more servers 101-1, 101-2, . . . , 101-n in a server bank or farm 100; a plurality of clients 121-1, 121-2, . . . , 121-m in a customer system 120; and a network 110, to which either the server farm 100 may be connected, or to which one or more of the servers within server bank 100 may be connected. The customer system 120 may be connected to network 110, or one or more of the clients within customer system 120 may be connected. The network 110 could be a high-speed connection, or a set of high-speed connections between the server farm 100 and the customer system 120, or in one embodiment, may be the Internet.

The servers in server farm 100 could be colocated, or could be located in various data centers in different geographic locations. Likewise, managed services customers could be hosted on servers that are colocated, or alternatively could be hosted on servers located in data centers in different geographic locations.

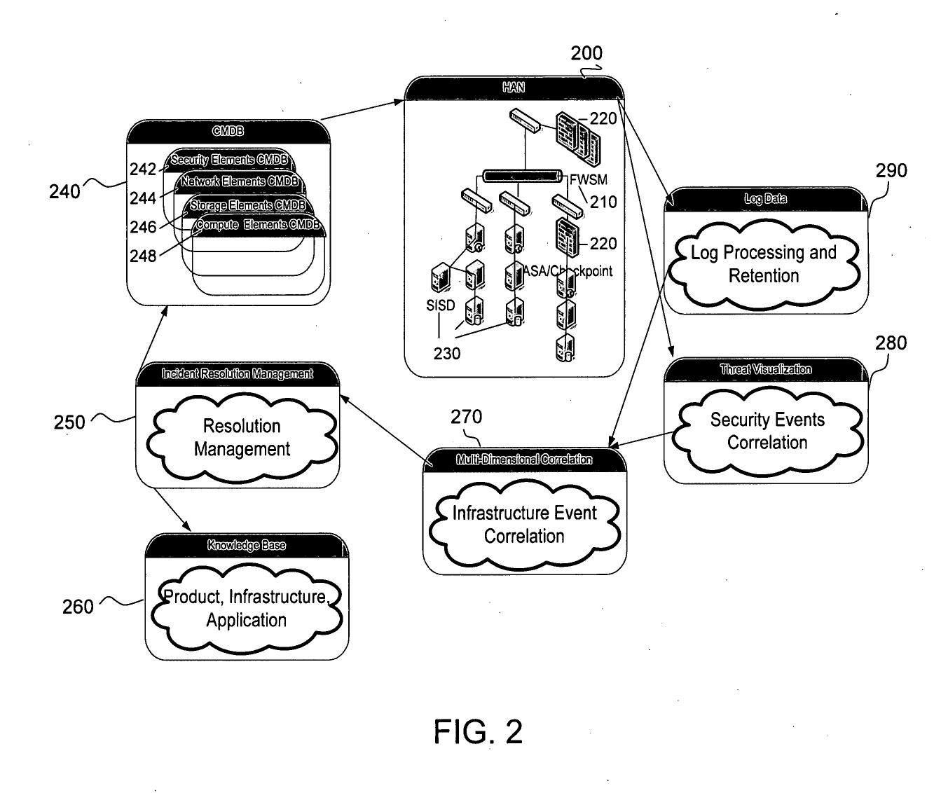

FIG. 2 depicts a high level hardware configuration including a network termed a hosting area network (HAN) 200. The HAN 200 may include hardware (including various kinds of servers, including server farm 100 and associated servers; possibly one or more storage area networks (SANs); accompanying networking infrastructure (including but not limited to backbones and routers); a firewall services module (FWSM) 210, and other firewall infrastructure 220 as needed. In FIG. 2, the firewall infrastructure may include technology from Cisco (including Cisco's ASA™). The servers may include computing devices with single instruction single data stream (SISD) processors 230.

In one aspect of the invention, HAN 200 contains the hardware for providing managed services to one or a plurality of customers. Each customer may have one or more servers dedicated to managing services for that customer. HAN 200 would also contain a platform for centralizing relevant information, including but not limited to types of assets; types of threats, and possible counters to different types of threats. Different customers may have different assets to protect; may be susceptible to different kinds of threats; and may operate in an environment in which different counters to common threats may have the same or varying degrees of effectiveness.

Turning back to FIG. 2, there are various modules which may comprise software housed on separate servers or common servers within HAN 200, or may be separate components themselves. One or more of these modules may be distributed among different servers and/or different customers, or may be housed centrally for use with a plurality of customers, or some combination of these possibilities. These modules include, among others, a configuration management database (CMDB) 240, which may include separate CMDBs for various aspects of managed services, including a security elements CMDB 242, a network elements CMDB 244, a storage elements CMDB 246, and a compute elements CMDB 248. These CMDBs 242-248 may reside on the same set of servers; a separate bank of centralized servers; or on servers used with particular customers, depending on the services being managed.

FIG. 2 also shows an incident resolution management module 250, a knowledge base module 260, a multi-dimensional correlation module 270, a threat visualization module 280, and a log data module 290. These modules are described in more detail in the above-mentioned copending application. For purposes of the present invention, not all of these modules may not be necessary. For example, as described in the copending application, different security threats to different customers in different environments may be more serious or less serious. Particular customer IT assets in different environments may have greater value or lesser value.

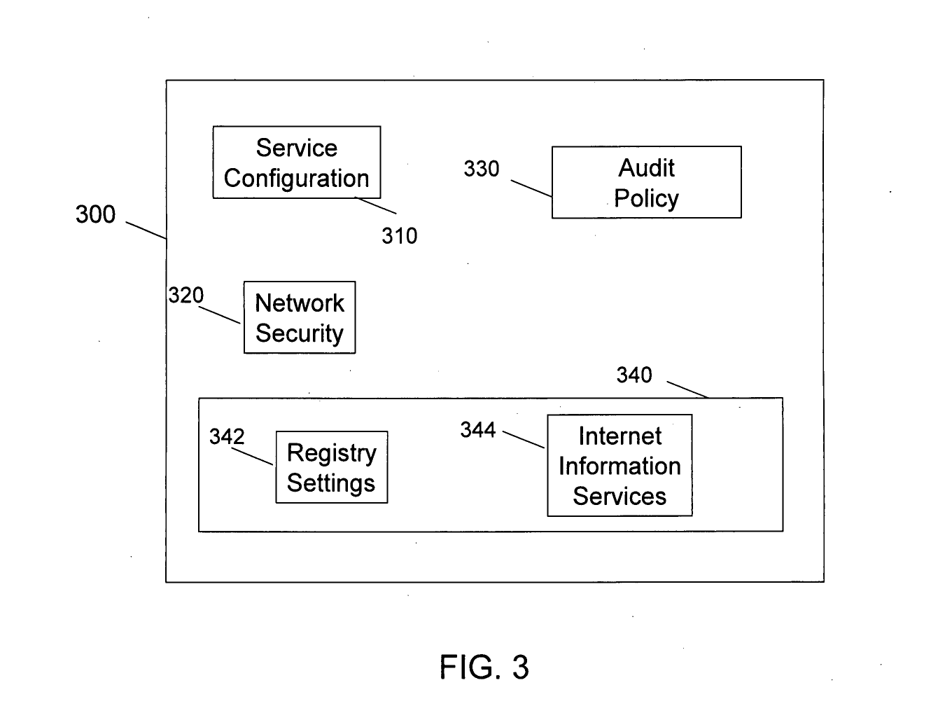

FIG. 3 shows a policy management module 300 which may be provided on one or more of the servers in server bank or farm 100 in accordance with one aspect of the present invention. In one aspect, policy management module 300 includes service configuration module 310, whose purpose is to facilitate configuration of managed services customer clients and servers as a function, among other things, of roles of particular servers, features that clients are supposed to have, and standards with which a particular customer complies, whether voluntarily or involuntarily. Actual setup of customer clients and servers may be handled in another aspect of the managed services for that customer. In service configuration module 310, service and port access needs are addressed.

One aspect of policy management module 300 is the ability to access policy information for different managed services customers from a single location. One consequence of this accessibility is the ability to see and compare policies for different managed services customers from the same location, thus facilitating possible recommendations for security changes after a security audit, as will be discussed in greater detail below.

Looking further at FIG. 3, network security module 320 may, for example, configure inbound ports for servers being utilized by a managed services customer. A port may be opened or closed, or traffic at particular ports may be restricted or configured for heightened security using a digital signature or encryption. The ability to address individual ports, in one aspect of the invention, enables greater granularity in setting policies for individual managed services customers instead of, for example, providing a blanket setting for opening or closing particular ports for entire groups of customers, or configuring a port in exactly the same way for all customers in that group. As will be discussed in greater detail below, the ability to control elements such as port access on an automated yet customized basis for individual managed services clients is an aspect of the present invention. Also, in one aspect, port traffic may be signed or encrypted using IPsec, a suite of protocols with which ordinarily skilled artisans will be familiar, and accordingly which need not be described in further detail here.

Depending on the operating system or on a particular firewall program being used, settings for Windows™ Firewall, or for another type of firewall (whether particular to a given operating system, or available as a third party program, or even developed by a managed services provider) may be configured.

Audit policy module 330 enables configuration of audits to be conducted on managed services customer policies. Audits can be tailored to enable, for example, a periodic review of a particular customer policy, irrespective of whether a violation has occurred. In this circumstance, it may be that particular events for that customer and policy are not audited. As one alternative, events concerning that policy can be monitored. During monitoring, an audit may be conducted if a violation occurs, or if a violation does not occur, or irrespective of whether a violation occurs.

Security setting module 340, as can be seen from FIG. 3, in some cases may be somewhat specific to the operating system(s) that the managed services customer is running. For example, the settings devised in this module, and ultimately part of a “pick list” from which a customer or a managed services provider may select, may be linked to instructions that are operating system specific. In one embodiment, the operating system may be selected from among various versions of Windows™. For example, in setting security policies, there have been certain actions that may have pertained to one or more of Windows NT™, Windows 2000™, Windows XP™, or Windows Vista™. In registry setting module 342, then, registry settings may be configured appropriately to the security policy or policies that a managed services customer may require. Inbound and outbound authentication protocols may be set. Service message block (SMB) security signatures or lightweight directory access protocol (LDAP) signing also may be handled in this section.

Continuing with the embodiment in which a Windows™ operating system is running on the customer hardware, a server may be configured to run a Web server role. In that circumstance, under Windows™, Internet Information Services (IIS) may be selected, thereby involving Internet Information Services module 344. As will be known to ordinarily skilled artisans, numerous services are available under IIS. Examples of possible interest, which may be displayed for selection, can include selection of web service extensions for dynamic content; selection of virtual directories to be retained; and prevention of anonymous users from accessing content files.

It should be noted that, in some instances, there will be managed services customers running different operating systems. The pick lists for those customers may be tailored according to those operating systems. Descriptions herein pertaining to Windows™ are exemplary and not intended to be limiting.

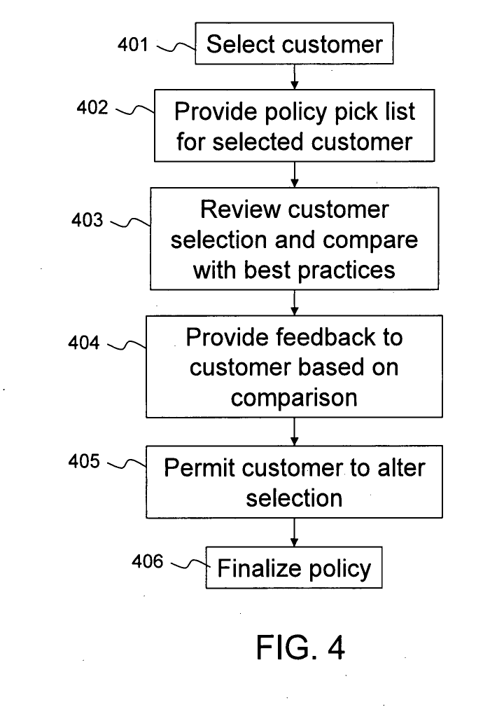

FIGS. 4-7 depict generally the devising of policies, the auditing of policies, and the provision of policy compliance feedback for customers. In FIG. 4, in one aspect of the invention, to determine a policy for a customer, once that customer is selected (401), a policy pick list may be provided for that customer (402). The pick list may be a generic list for customers in different industries or security scenarios, or may be particular to a given industry segment or security scenario. In 403, a customer may be permitted to select from that pick list. In 403, the customer selection also can be reviewed and compared with known best practices, or in some instances, with selections of similarly situated managed services customers. In 404, the customer may be provided with feedback and, where appropriate, suggestions for policy alteration may be provided. Once the customer is offered the opportunity to alter the original selection (405), in 406, the policy may be finalized.

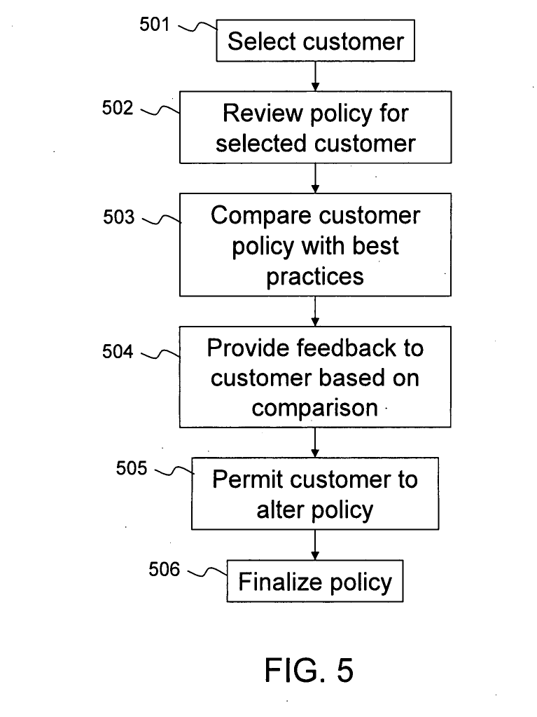

Periodic policy audits may be appropriate based on changes in desired best practices, changes in customer security needs, or the like. FIG. 5 is a flow chart outlining how such audits might be conducted. For a given customer (501), the policy is reviewed (502). The policy may have been derived from a pick list, as described with respect to FIG. 4; it may have been provided as a standard policy for that customer; or it may have been mandated by a particular version of an industry standard with which the customer is complying or is required to comply. At 503, the customer policy is compared with known best practices, which may be determined by industry standards, or by the managed services provider, or in another way known to ordinarily skilled artisans. At 504, the customer may receive feedback on compliance with best practices, and at 505, may be permitted to alter policy accordingly. The policy then is finalized at 506.

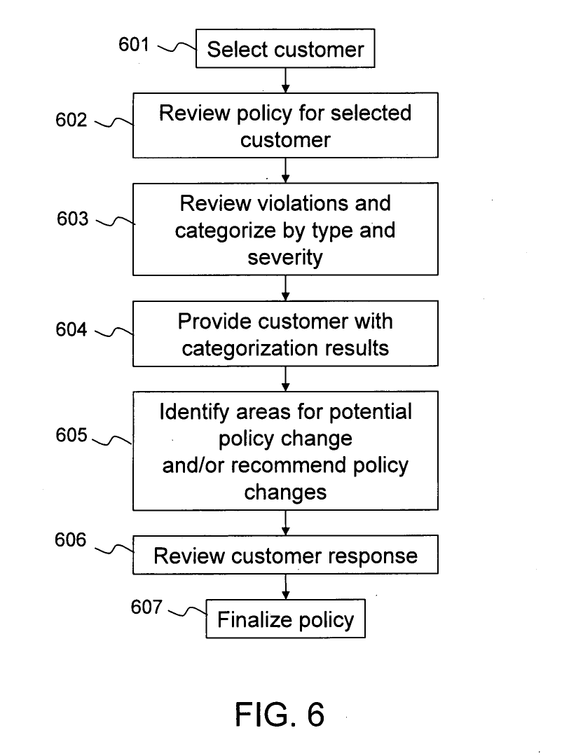

In FIG. 6, another type of audit, in which security violations are reviewed, is described. Again, for a particular customer (601), the customer policy may be reviewed (602). Either as part of that review, or in addition to that review, security violations for that customer may be categorized by type and severity (603). In one aspect, this categorization may be carried out according to customer asset(s) at risk, a weighted value the customer may assign to the asset(s), and/or the perceived threat severity for that customer. This type of threat management is discussed in more detail in the above-referenced copending application.

At 604, the customer may be provided with results of the violation assessments and categorizations. At 605, the customer may be provided with areas for potential policy change according to customer need. In one aspect, policy changes may be recommended. Any customer response may be reviewed (605), and the policy then finalized (607).

While FIGS. 4-6 provide examples in which particular customers are singled out for policy selection or audit, a managed services provider also may group customers within a particular industry segment together and deal with their policy needs on a grouped basis, with policy selection, feedback, and auditing being handled on a more widespread basis rather than on a particularized basis. Whether done as a group or individually, the managed services provider is able to take advantage of data for similarly situated customers in devising policies, auditing policies, and making recommendations for policy alteration or amendment.

Also in FIGS. 4-6, where a customer decides to make policy changes, these may be handled automatically, or may be handled by presenting the customer with the same pick list as originally provided, or a pick list which may have been revised based on changes in best practices, for example.

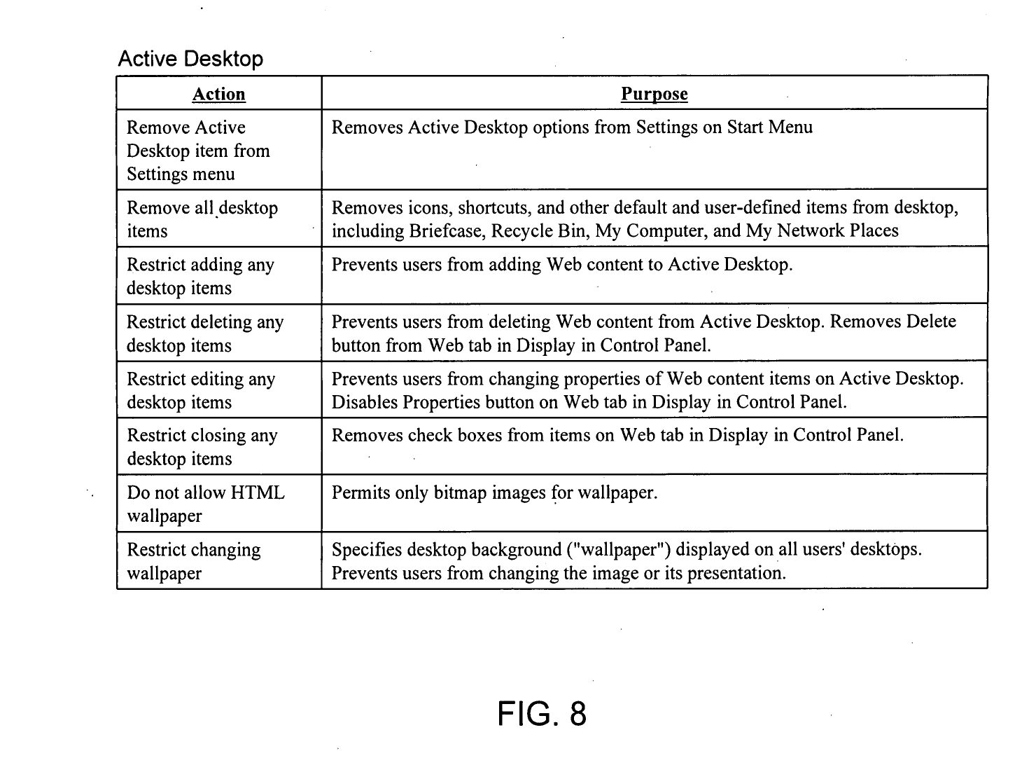

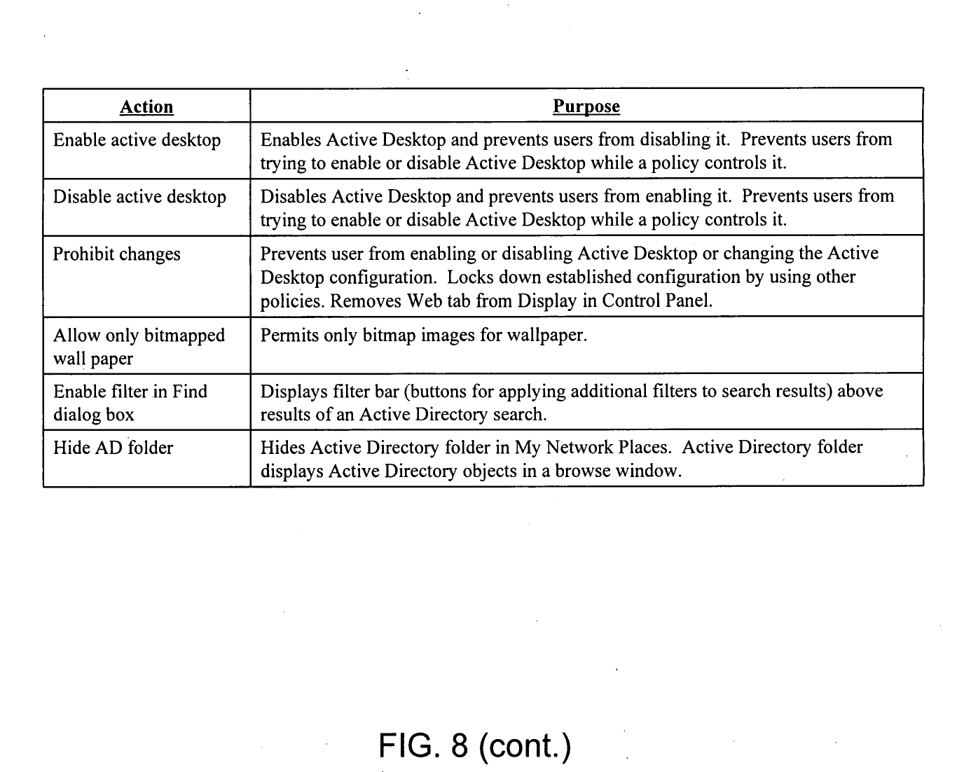

In one aspect of the invention, prior to conducting any policy audits for managed services customers, either the customer or the managed service provider may select an initial policy or set of policies to be implemented. If the managed services provider selects the initial policy or policy set, this may be done based on experience with similar customers or similar security situations, or may be done from an updated review of security issues for current customers. If the customer selects the initial policy or policy set, this may be done in accordance with selections from pick lists such as the ones shown in FIGS. 8-11.

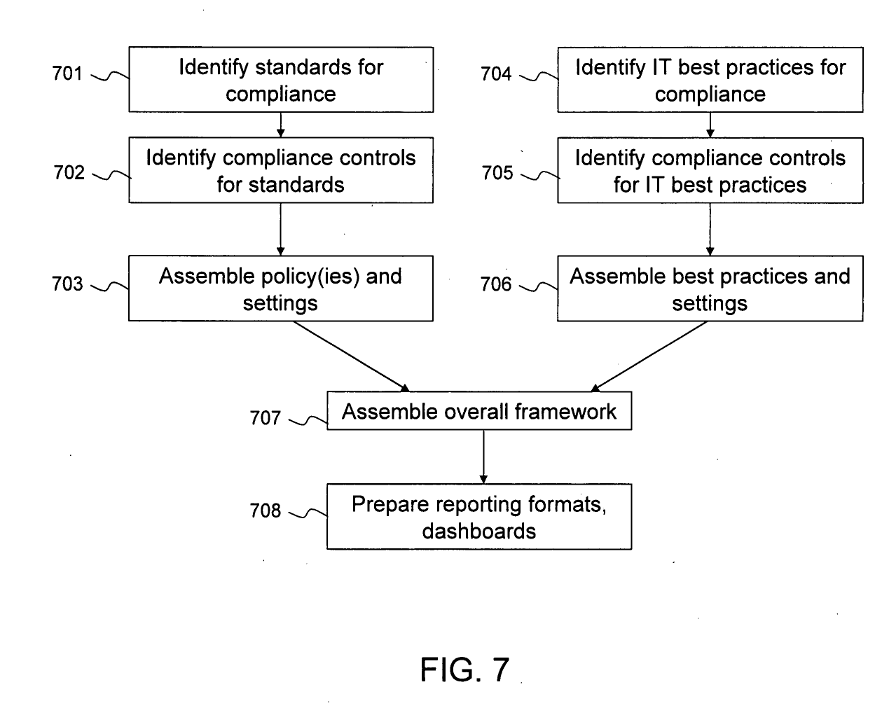

Before proceeding to FIGS. 8-11, FIG. 7, depicting one aspect of the invention in which regulatory standards and/or IT best practices for compliance may be selected for implementation and subsequent feedback from a managed services provider, will be described.

In FIG. 7, at 701 one or more appropriate regulatory standards may be selected for compliance. Examples of some regulatory standards were provided above. In one aspect of the invention, a managed services customer may make this selection. However, while rather unlikely given the nature of the selection, a managed services provider may make that selection for the customer. At 702, the customer generally will select, in some instances from a dashboard or pick list, compliance controls for the standard(s). Policies and policy settings may be selected at 703.

Looking at the IT security side of the equation, at 704 either the managed services customer or the managed services provider may identify IT best practices for compliance. At 705, the compliance controls that go with those best practices may be selected. Various exemplary IT standards were listed above. At 706, best practices and settings may be assembled.

It is not necessary that both 701-703 and 704-706 be implemented according to the invention. However, if they are, then at 707, an overall framework will be assembled. At 708, reporting formats, including dashboards, may be prepared. If only 701-703 or 704-706 are implemented, then 708 may follow without 707 intervening.

FIGS. 8-11 provide Windows™-based examples, but other examples for other operating systems will be known to ordinarily skilled artisans. Looking first at FIG. 8, one example of a possible pick list for options in a Windows™ feature known as Active Desktop, in which a user or customer can have a desktop act or behave like a Web page. Some of the options in the FIG. 8 pick list, such as Briefcase, Recycle Bin, My Computer, My Network Places, Control Panel, are Windows™ specific. However, there may be analogs in other operating systems. For example, in Mac OS X, “Recycle Bin” would be “Trash”. “Control Panel” might be “System Preferences”. Other comparisons will be known to ordinarily skilled artisans. The pick lists can be amended based on the options that different operating systems provide.

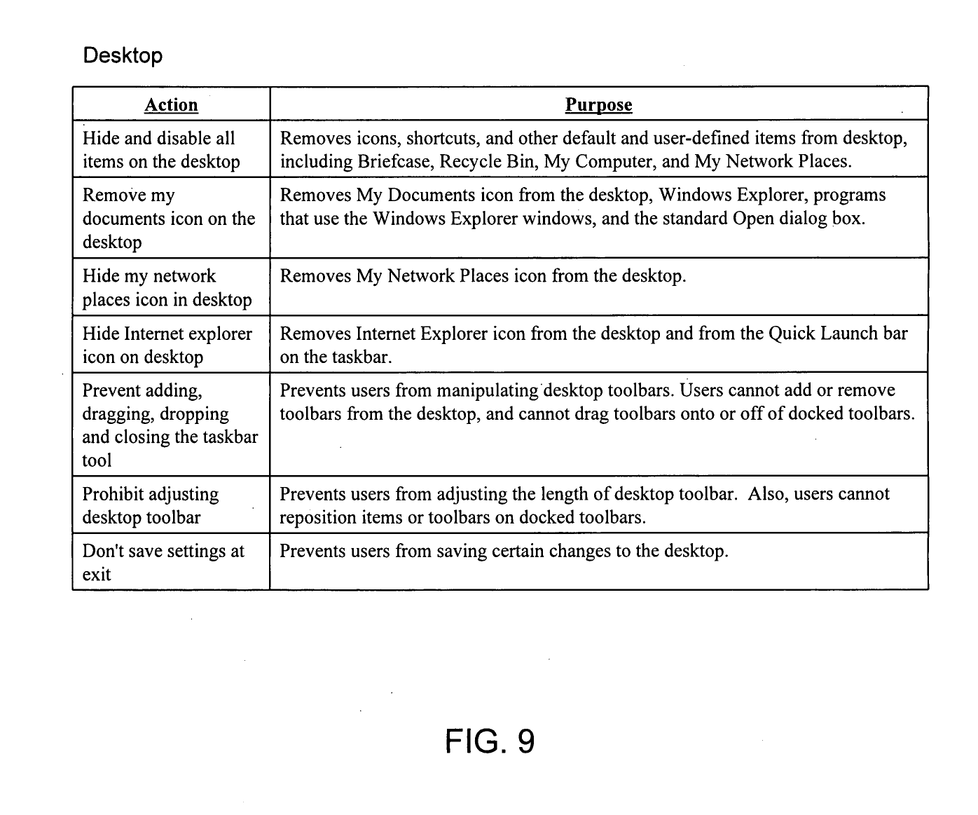

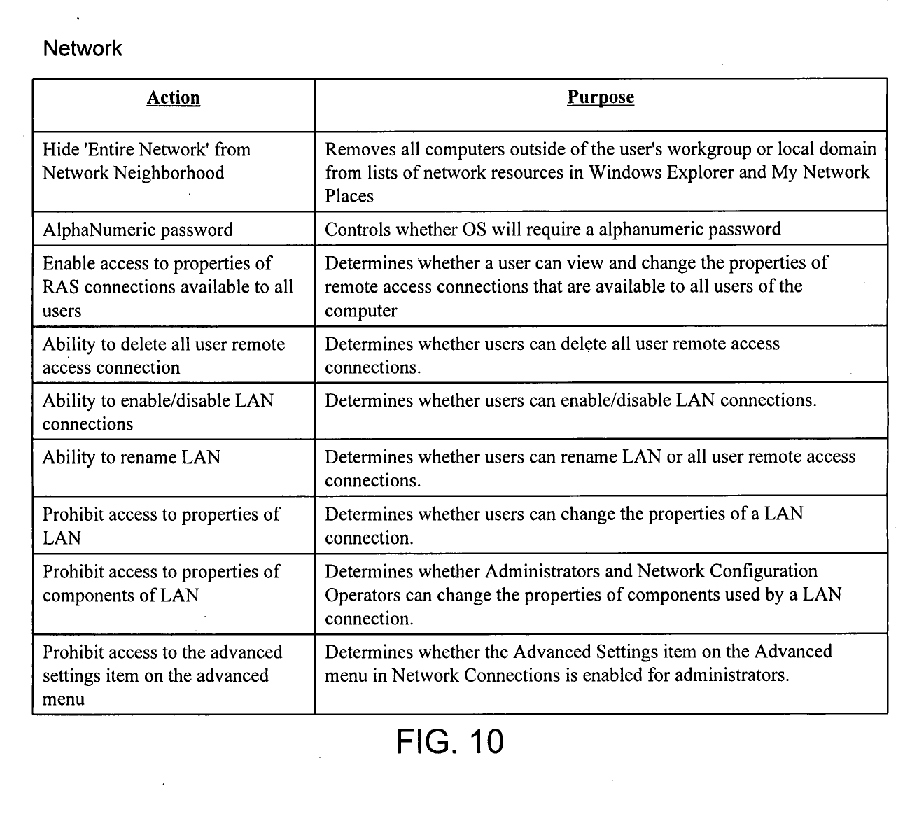

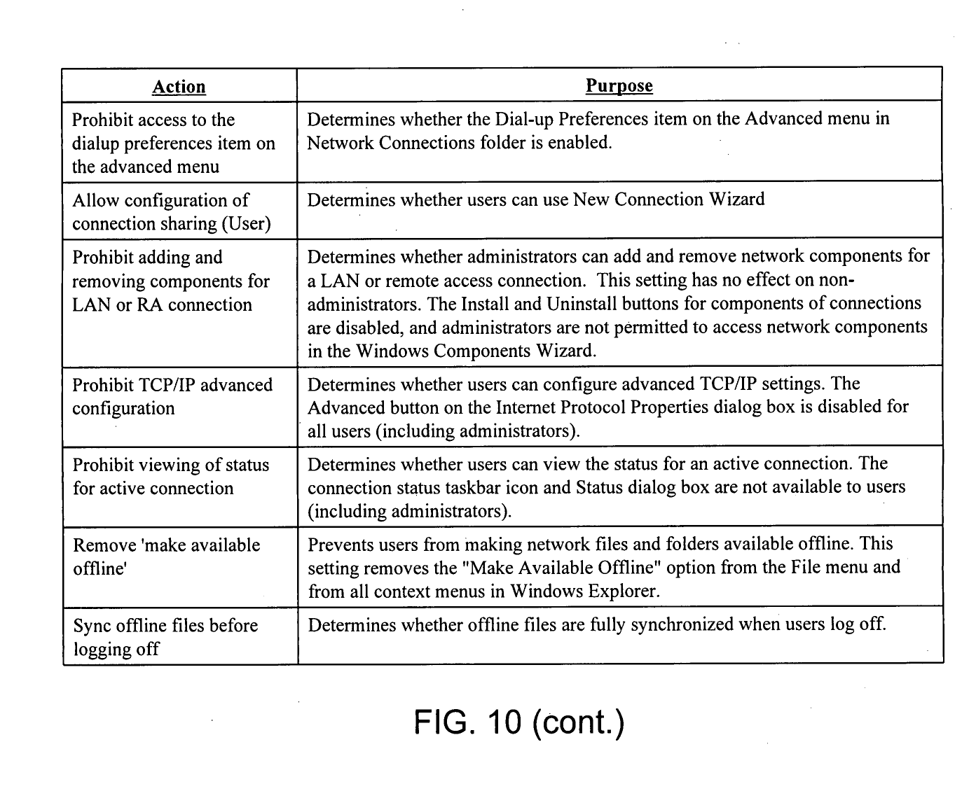

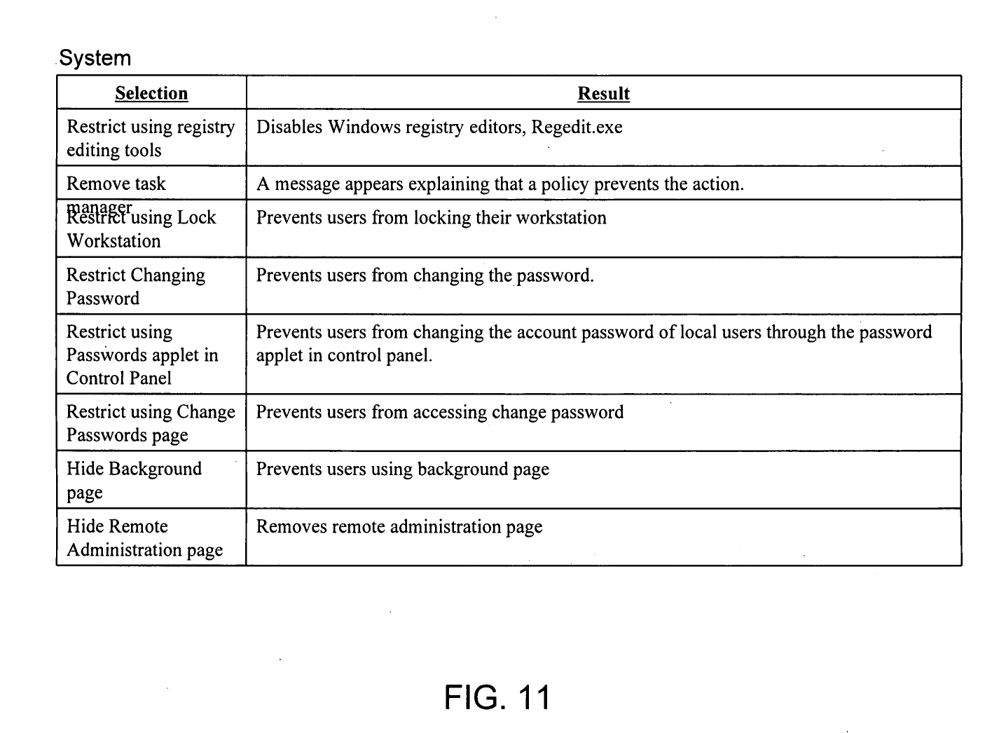

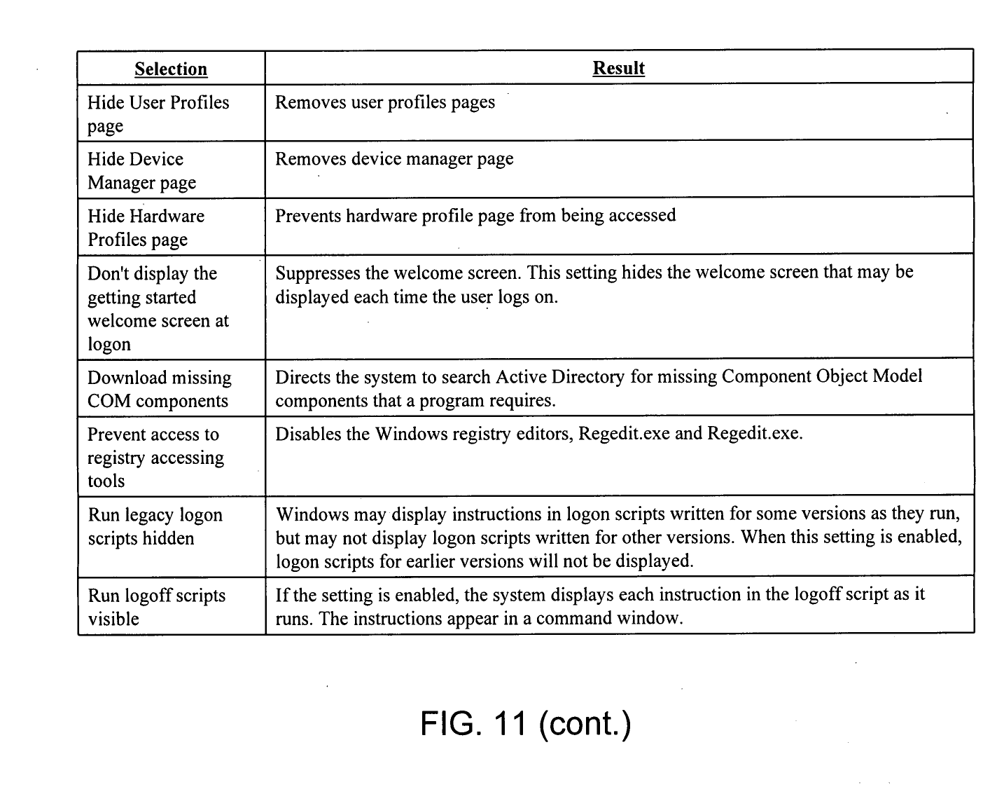

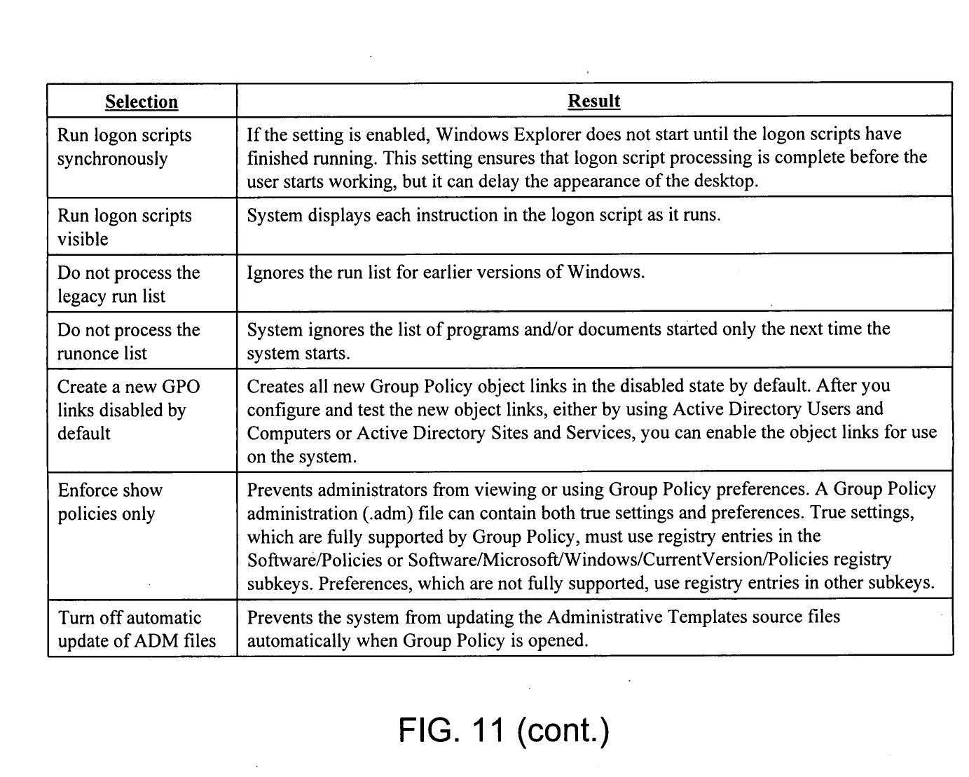

FIG. 9 shows a pick list for selectively permitting or prohibiting changes to a user desktop. Again, Windows™ options, for example, may be different from Mac OS X options for desktop restrictions. FIG. 10 shows a pick list for selectively permitting or prohibiting access to the network to which terminals may be connected. Network connectivity options, password protection, network access options, and configuration options, among others shown in this Figure, may be controlled. FIG. 11 shows a pick list for system options. Users may be permitted to or prohibited from making changes to parts of their workstations.

It should be noted that the foregoing descriptions of security actions, including potential items on customer pick lists as part of policy setting, as well as certain utilities and programs used in defining security policies, are Windows™ based. The pick lists in FIGS. 8-11 were made fairly specific to show customer choices in a Windows™ environment. Ordinarily skilled artisans will be well aware that, for other operating systems, including but not limited to Linux, the various available versions of Unix™, and Mac OS™, including various versions of Mac OS 9 and OS X, corresponding pick lists can be devised without undue effort. Some of the items in the possible pick lists of FIGS. 8-11 may not be possible, or even required in non-Windows™ operating systems. This, too, will be apparent to ordinarily skilled artisans.

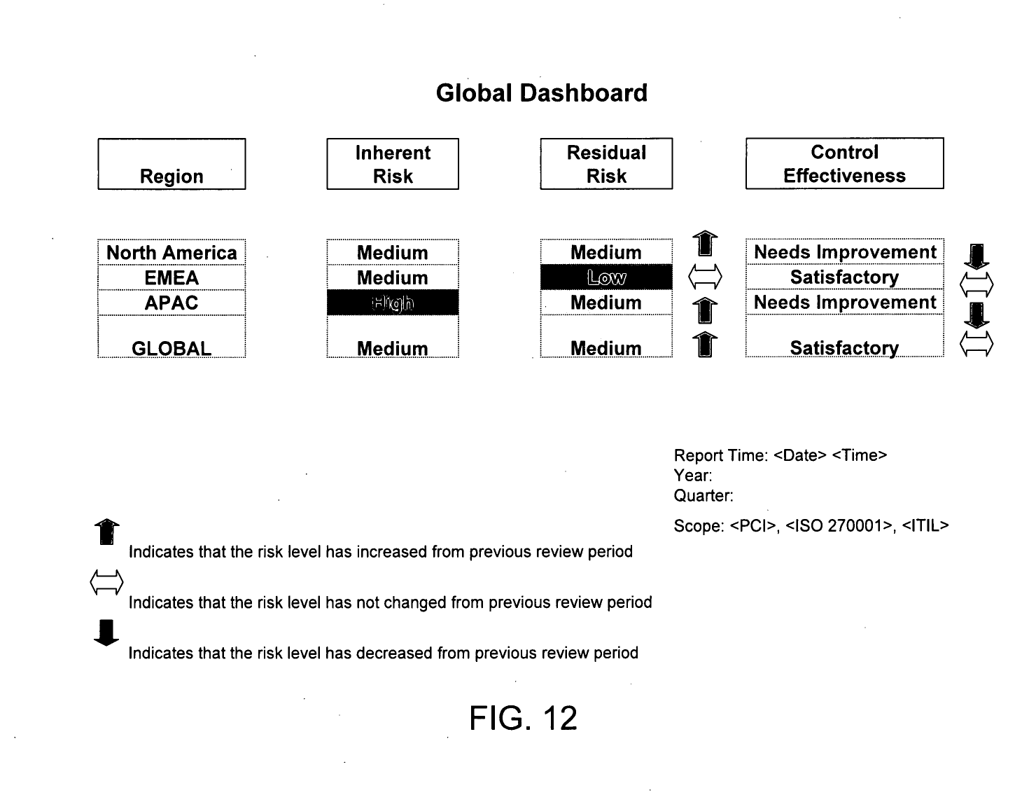

FIG. 12 shows one example of a dashboard which may display risk assessment for a particular managed services customer or group of customers. FIG. 12 contains a couple of aspects of interest. First, threat assessment and policy compliance are broken down by geographic region. North America, Europe, Asia-Pacific, and Global regions are shown by way of example, but other such breakdowns are easily configured. Another aspect of interest is the ability of this dashboard to present comparison of most recent results with previous results, whether from an immediately preceding audit, for example, or from an earlier audit.

Yet another aspect of interest is the display of results of the comparison, in terms of whether the current policy is satisfactory or needs improvement. If a particular policy is recommended for improvement, a user may be presented with an appropriate pick list from which to make an amended set of selections. As noted previously, risk assessments may change not only because of past customer selections, but also because of changes in standards compliance requirements within an industry.

The dashboard shown in FIG. 12 may be presented directly to a managed services customer, or may be provided to the managed services provider. The provider may present recommendations in a different manner to a customer.

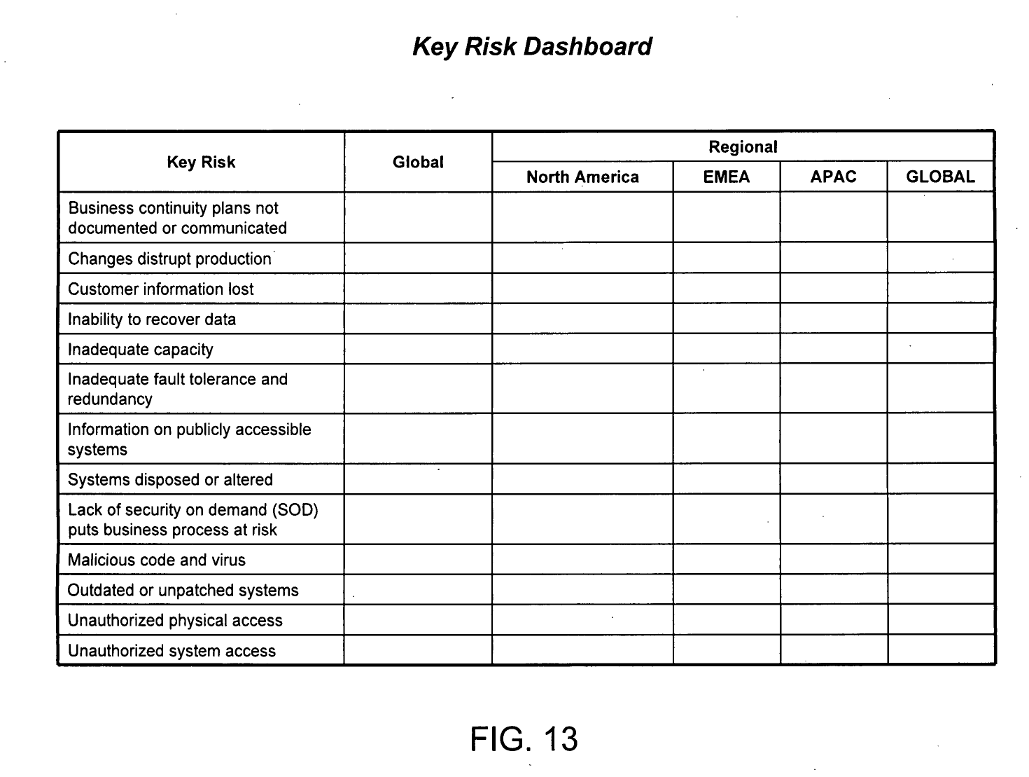

FIG. 13 shows another type of dashboard identifying security or other policy risks which managed services customers may face. The prevalence of one or more of these risks on a global or regional basis may prompt changes in customer policy. For example, the introduction of threats such as viruses or malicious code in certain regions may signify persistent attacks, and may motivate heightened security policy in those regions. The other risks shown in FIG. 13 also may prompt different security responses, again on a regional or global basis, depending on the circumstance.

While the invention has been described in detail above with reference to some embodiments, variations within the scope and spirit of the invention will be apparent to those of ordinary skill in the art. Thus, the invention should be considered as limited only by the scope of the appended claims.

What is claimed is:

1. A method of facilitating customer standards compliance, the method comprising:
providing one or more pick lists from which customers can select items;
implementing rules corresponding to the items selected;
comparing results of the implementing with one or more standards with which a customer must comply; and
advising said customer regarding its compliance;
wherein the providing of pick lists is tailored in accordance with specific customer requirements for compliance.

2. A method as claimed in claim 1, wherein the pick lists and rules relate to processing of data that customers are required to maintain for policy compliance.

3. A method as claimed in claim 1, wherein the pick lists and rules relate to payment policy compliance.

4. A method as claimed in claim 1, wherein the pick lists and rules relate to health care policy compliance.

5. A method as claimed in claim 1, further comprising, for each standard with which one or more customers must comply, identifying best practices for compliance,
wherein the advising comprises comparing customer selection with a corresponding one of said best practices and communicating recommendations for alteration of the customer selection.

6. A method as claimed in claim 1, further comprising monitoring said customer standards compliance.

7. A method as claimed in claim 1, further comprising editing said pick lists in accordance with changes in best practices for standards compliance.

8. A method as claimed in claim 1, wherein said pick lists are developed in accordance with an operating system that a customer is running.

9. A method as claimed in claim 1, further comprising comparing the results with results of a previous audit, and advising a customer regarding the comparison.

10. A method as claimed in claim 9, further comprising re-presenting the one or more pick lists to the customer to enable changes in items selected.

11. A method as claimed in claim 6, further comprising re-presenting the one or more pick lists to the customer based on results of said monitoring.

12. A method of managing customer policy compliance, the method comprising:
enabling identification of policies for compliance;
enabling identification of controls for compliance with said policies;
assembling settings for selecting and changing said controls.

13. A method as claimed in claim 12, wherein the policies relate to industry compliance standards.

14. A method as claimed in claim 12, wherein the policies relate to information technology (IT) security standards.

15. A method as claimed in claim 12, wherein the policies relate to industry compliance standards and information technology (IT) security standards.

16. A method as claimed in claim 12, wherein a managed services customer identifies the policies for compliance.

17. A method as claimed in claim 12, wherein a managed services provider identifies the policies for compliance.

18. A method as claimed in claim 12, wherein a managed services customer identifies the controls.

19. A method as claimed in claim 12, wherein a managed services customer identifies the controls.

20. A method as claimed in claim 12, further comprising comparing identified settings with best practices for compliance and providing feedback based on the comparison.
